(19) United States
(12) Patent Application Publication
(10) Pub. No.: US 2026/0269725 A1
(43) Pub. Date: Sep. 10, 2026

(54) REGULATORS HAVING ERROR AMPLIFIERS WITH IMPROVED LOAD TRANSIENT PERFORMANCE

(71) Applicant: Micron Technology, Inc., Boise, ID (US)

(72) Inventors: Alimi Rakesh Kumar, Jagityal (IN); Leela Madhav Lakkimsetti, Bangalore (IN)

(21) Appl. No.: 19/548,394

(22) Filed: Feb. 24, 2026

Related U.S. Application Data
(60) Provisional application No. 63/767,939, filed on Mar. 6, 2025.

(51) Int. Cl. H02M 3/156; G05F 1/46; G05F 1/569; G05F 1/575; H02M 1/00; H02M 3/157; H02M 3/158

(52) U.S. Cl. CPC H02M 3/1566; G05F 1/462; G05F 1/569; G05F 1/575; H02M 1/0032; H02M 3/157; H02M 3/1582

(57) ABSTRACT

Apparatuses and methods for operating a regulator having an error amplifier with improved load transient performance are described. For example, the output of the error amplifier can be stabilized faster over the load transient. This can be done by dynamically controlling a resistance coupled to an input of the error amplifier.

### PRIORITY INFORMATION

This application claims the benefit of U.S. Provisional Application No. 63/767,939, filed on Mar. 6, 2025, the contents of which are incorporated herein by reference.

### TECHNICAL FIELD

The present disclosure relates generally to electronic apparatuses and methods, and more particularly, to apparatuses and methods related to regulators having error amplifiers with improved load transient performance.

### BACKGROUND

Voltage regulators play essential roles in supplying power to subsystems with distinct voltage and current needs. Linear regulators offer simplicity and low noise, while switching regulators, such as buck, boost, and buck-boost converters, achieve high efficiency for variable loads. For example, power management integrated circuits (PMICs) often integrate multiple voltage regulators and other functions, reducing board space and complexity while ensuring precise coordination across power rails in devices like smartphones, laptops, and embedded systems.

### BRIEF DESCRIPTION OF THE DRAWINGS

FIG. 1 illustrates an example electronic system that includes a voltage regulation component in accordance with some embodiments of the present disclosure.

FIG. 2 illustrates a switching voltage regulator having an error amplifier with improved load transient performance in accordance with some embodiments of the present disclosure.

FIG. 3 illustrates an error amplifier having a dynamically adjustable resistance in accordance with some embodiments of the present disclosure.

FIG. 4 illustrates a number of graphs showing transient responses of a regulator having an error amplifier with improved load transient performance in accordance with some embodiments of the present disclosure.

FIG. 5 is a flow diagram corresponding to a method for operating a voltage regulator having an error amplifier with improved load transient performance in accordance with some embodiments of the present disclosure.

### DETAILED DESCRIPTION

Systems, apparatuses, and methods related to regulators having error amplifiers with improved load transient performance are described. Switching voltage regulators, such as Constant-On-Time (COT) DC-DC converters, are employed in various electronic systems to efficiently regulate output voltage across a range of load conditions. To maintain stable output voltage, these converters may employ an error amplifier loop in addition to the main control loop. This error amplifier, often characterized by a high DC gain, plays a critical role in ensuring precise output voltage regulation. However, its high DC gain can also lead to significant challenges, especially during light-load, low switching frequency operations.

One key issue arises from the error amplifier's tendency to saturate under light load conditions. In situations where the converter operates at a lower switching frequency, the high DC gain drives the output of the error amplifier into saturation. If a sudden increase in load (e.g., from light load to full load) occurs, the error amplifier is desired to recover from its saturated state to respond appropriately to the transient demand. This delay in recovery can result in a considerable undershoot in output voltage, compromising the voltage regulation during load transients and impacting overall converter performance.

To mitigate this saturation problem, some approaches often include placing a clamp on the error amplifier output. The clamp serves to limit the error amplifier output drift under light-load conditions, preventing excessive deviation from the steady-state value. However, the effectiveness of this approach heavily depends on the clamped output value being close to the required steady-state value. For example, variability in manufacturing processes, voltage, and temperature (PVT) can introduce mismatches, making it challenging to accurately set the clamp level. Accordingly, even with the clamping technique, undershoot during load transients may still occur if the clamped error amplifier output is not precisely aligned with the steady-state operational value. This illustrates the need for improved approaches that effectively minimize output voltage undershoot during load transients while addressing the limitations of clamping techniques of some approaches under varying conditions.

Aspects of the present disclosure address the above and other challenges by providing selective resistance adjustment to achieve the reduced output voltage undershoot and the improved error amplifier's performance in responding to the load transients, such as when transitions from a discontinuous conduction mode (DCM) to a continuous conduction mode (CCM), causing the coil current (alternatively referred to as the inductor current) to increase from 0 Amps. For example, embodiments of the present disclosure leverage a dynamic bandwidth adjustment mechanism that varies the resistance (coupled to one of inputs to the error amplifier circuit) based on the DC-DC converter's mode of operation. During the conduction phase, when the inductor current flows continuously, the resistance can be dynamically adjusted to a higher value, aligning an error amplifier output closer to its steady-state. In contrast, when the inductor current drops to zero, the resistance can be dynamically adjusted to be reduced, allowing the error amplifier output to recover faster in anticipation of a potential load increase. This dynamic resistance adjustment accelerates the slew rate of the error amplifier output during critical moments, minimizing the output voltage undershoot and enhancing the transient response without introducing additional power or complex circuitry. Further, the simplicity of this design allows it to be easily incorporated into existing systems with minimal modifications, addressing the drawbacks of conventional clamping techniques and significantly improving light-load transient performance.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected. It is to be understood that data can be transferred, read, transmitted, received, or exchanged by electronic signals (e.g., current, voltage, etc.).

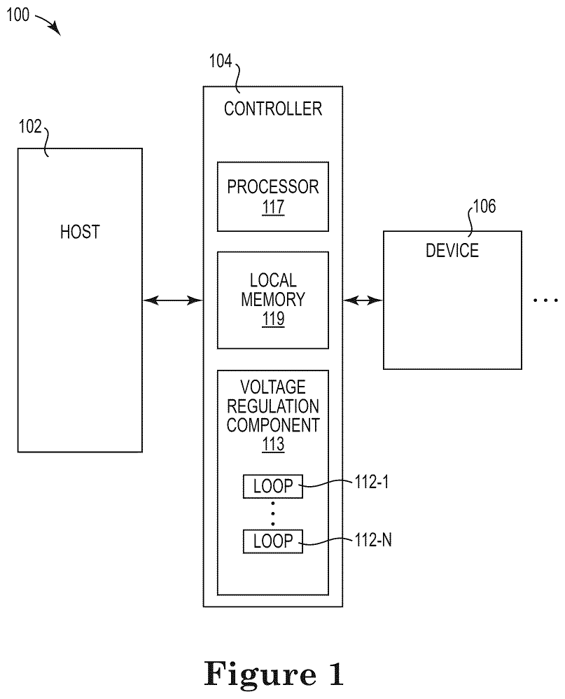

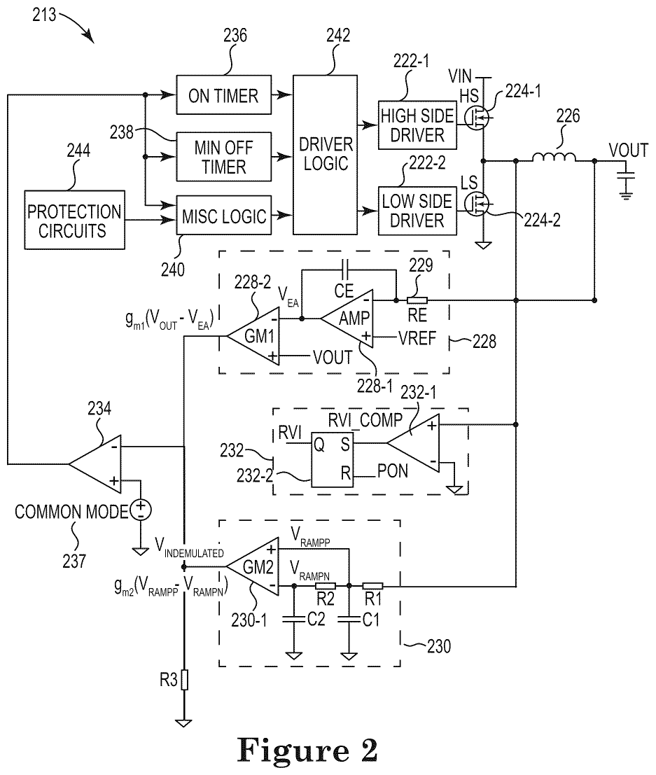

The figures herein follow a numbering convention in which the first digit or digits correspond to the drawing figure number and the remaining digits identify an element or component in the drawing. Similar elements or components between different figures may be identified by the use of similar digits. For example, 113 may reference element “13” in FIG. 1, and a similar element may be referenced as 213 in FIG. 2. Analogous elements within a Figure may be referenced with a hyphen and extra numeral or letter. See, for example, elements 112-1, . . . , 112-N in FIG. 1. Such analogous elements may be generally referenced without the hyphen and extra numeral or letter. For example, elements 112-1, . . . , 112-N may be collectively referenced as elements 112. As used herein, the designators “N”, particularly with respect to reference numerals in the drawings, indicate that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 illustrates an example electronic system 100 that includes a host 102, a controller 104, and a device 106 in accordance with various embodiments of the present disclosure. While the electronic system 100 can be considered as an apparatus, embodiments are not so limited. For example, the host 102, the controller 104, and the device 106 can each separately be considered as an apparatus.

The electronic system 100 can be, or can be part of, for example, a desktop computer, laptop computer, televisions, home theater system, gaming console, digital camera, network router and/or switch, printer, scanner, medical device, GPS navigation device, home device (e.g., thermostat, doorbell camera, security camera, smart lock, etc.), wearable device, industrial control system (e.g., automated industrial and/or control device) mobile computing device, a vehicle (e.g., airplane, drone, train, automobile, or other conveyance), Internet of Things (IoT) enabled device, embedded computer (e.g., one included in a vehicle, industrial equipment, or a networked commercial device), system-on-chip (SoC), chipset (e.g., a collection of integrated circuits), tile, Field-Programmable Gate Array (FPGA) structure (e.g., segmented FPGA structure), or other such device.

The electronic system 100 can be, or can include, a computing fabric. As used herein, the term “computing fabric” generally refers to a conveying, multiplexing, network, computing, or communication topology in which components pass data to each other through interconnecting switches, hubs, routers, multiplexers, buses, transmission lines and rings, cables, optical couplers and fibers, electromagnetic devices, or various other means. For example, a “computing fabric” can include various components (e.g., interconnects, crossbars, networks on chip, token rings, etc.) within a computing, memory, data storage and/or processing, network and/or telecommunication, artificial intelligence, control and/or telemetry, digital entertainment and/or other system, that facilitates in-chip and/or inter-chip communication.

The electronic system 100 includes a host 102. The host 102 can include a processor chipset and a software stack executed by the processor chipset. For example, the host 102 can be, or can include, a central processing unit (CPU) or a CPU complex that can be configured to execute an operating system.

The host 102 can be coupled to the controller 104 via a physical and/or logical host interface that operates based on various communication protocols and to provide control, address, data, and other signals to the controller 104 (e.g., to further cause the controller 104 to control the device 106). Examples of the interface between the host 102 and the controller 104 can include, but not limited to, a bus interface (e.g., a serial advanced technology attachment (SATA) interface, a Serial Attached SCSI (SAS) interface, a Serial Attached SCSI (SAS) interface, a Small Computer System Interface (SCSI), a peripheral component interconnect express (PCIe) interface, ISA, etc.), a memory interface (e.g., a double data rate (DDR) interface, a dual in-line memory module (DIMM) interface, an Open NAND Flash Interface (ONFI) interface, an NVM Express (NVMe) interface), a Fibre Channel, an UART interface, an I2C interface, a Serial Peripheral Interface (SPI), an Universal Serial Bus (USB) interface, an ethernet interface, a general-purpose input/output (GIPO) interface, a custom interface, etc.

The controller 104 is communicatively coupled to one or more electronic devices 106 such that signaling can be exchanged therebetween. Non-limiting examples of the devices 106 can include microcontrollers, microprocessors, digital logic circuits, analog circuits, light emitting diodes (LEDs), displays, sensors, motors, actuators, audio amplifiers, radio frequency (RF) circuits, test and measurement instruments (e.g., oscilloscopes, multimeters, etc.), automotive electronics, medical devices, telecommunication equipment, memory devices (e.g., volatile and/or non-volatile memory devices), graphics processing units, processors/co-processors, logic blocks, intellectual property (IP) cores, etc. As used herein, a “core” or “IP core” generally refers to one or more blocks of data and/or logic that form constituent components of an application-specific integrated circuit or field-programmable gate array. The circuit portion areas can be designed, built, and/or otherwise configured to perform specific tasks and/or functions within the systems described herein.

As shown in FIG. 1, the controller 104 can include a processing device (e.g., processor 117) that can execute instructions stored in a local memory 119 to perform various operations described herein. The controller 104 can include various special purpose circuitry in the form of an ASIC, FPGA, state machine, and/or other logic circuitry that can perform operations described herein. As an example, the controller 104 can be a memory controller.

In various embodiments, one or more constituent components (e.g., host 102, controller 104, device 106, etc.) of system 100 can be part of a SoC. In one example, a device 106 itself can correspond to an SoC, while the host 102 and the controller 104 are considered “external” to the SoC. In another example, the host 102 or the controller 104, or both, can be considered as a part of an SoC along with the device 106 being internal or external to the SoC.

In some embodiments, a device 106 can be a storage device, a memory module, or a hybrid of a storage device and memory module. Examples of a storage device include an SSD, a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

For example, the electronic device 106 can be a volatile or non-volatile memory device. In some embodiments, the electronic device 106 can be a DRAM array, SRAM array, STT RAM array, PCRAM array, TRAM array, RRAM array, NAND flash array, and/or NOR flash array, for instance. The arrays can comprise memory cells arranged in rows coupled by access lines (which may be referred to herein as word lines or select lines) and columns coupled by sense lines (which may be referred to herein as digit lines or data lines).

As shown in FIG. 1, the controller 104 can include a voltage regulation component 113 (e.g., a voltage regulator and/or converter). The voltage regulation component 113 can include one or more voltage regulators (e.g., the voltage regulator 213 shown in FIG. 2). The regulators can include a low-dropout (LDO) regulator, a buck-boost converter, a buck regulator, a boost regulator, or combination thereof, although embodiments are not so limited.

As shown in FIG. 1, the voltage regulator 113 can be implemented with one or more loop systems (“loop” shown in FIG. 1), such as loop systems 112-1, . . . , 112-N (collectively referred to as loop systems 112) with at least one of the loop systems 112 including an error amplifier (e.g., the error amplifier 228-1 with the improved load transient). Further details of the voltage regulator 113 are described in connection with FIG. 2.

FIG. 2 illustrates a switching voltage regulator 213 having an error amplifier 228-1 with improved load transient performance in accordance with some embodiments of the present disclosure. Although embodiments are not so limited, the switching voltage regulator 213 may include step-up, step-down, or buck-boost DC-DC converters.

The regulator 213 includes two drivers 222-1 (“HIGH SIDE DRIVER”), 222-2 (“LOW SIDE DRIVER”) that are respectively coupled to, and configured to control, switching elements or switches (alternatively referred to as “transistors”) 224-1, 224-2. The “HIGH SIDE” driver 222-1 is configured to control the transistor 224-1 that is placed between the power supply (“VIN” shown in FIG. 2 and alternatively referred to as “power source”) and one side of the inductor 226, while the “LOW SIDE” driver 222-2 is configured to control the transistor 224-2 that is placed between the (e.g., positive) one side of the inductor 226 and ground (GND). For example, the driver 222-1 can generate and apply a control signal to switch on the high-side transistor 224-1, allowing current to flow from the positive power supply (“VIN” shown in FIG. 2) through the inductor 226 to “VOUT”. For example, the driver 222-2 can generate and apply a control signal to switch the low-side transistor 224-2 on, allowing current to flow from the ground through the inductor 226 to “VOUT” via the transistor. Although embodiments are not so limited, the transistors 224-1, 224-2 can be metal-oxide-semiconductor field-effect (MOFSET) transistors.

The driver logic 242 can control the drivers 222-1 and 222-2 in conjunction with various circuitry configured to provide timing, determining when the low and/or high switches are to be activated or deactivated, thereby alternating between the on-cycle and off-cycle. As used herein, the term “on-cycle” refers to the period during which switch 224-1 is active (switched on), while the term “off-cycle” refers to the period during which switch 224-2 is active (switched on). The on-cycle and off-cycle alternate, defining a duty cycle (the percentage of the “on-cycle” within a particular period of time).

For example, the driver logic 242 can control the duration for which the high-side switch 224-1 remains on based on timing indication provided from the timer 236 (“ON TIMER” shown in FIG. 2), determining how much energy is delivered to the inductor 226 (configured to provide “VOUT” shown in FIG. 2 and alternatively referred to as an output inductor) and output load (receiving power from the regulator 213) during each switching cycle. For example, the driver logic 242 can operate to ensure that the low-side switch 224-2 remains on (after the high-side switch turns off) for a minimum specified time based on timing indication provided from the timer 238 (“MIN OFF TIMER” shown in FIG. 2), preventing excessive switching and ensuring stability in the operation of the regulator. For example, the driver logic 242 can manage additional control functions, such as fault protection (overcurrent, thermal shutdown, overvoltage protection), mode transitions, and synchronization with other parts of the system, ensuring safe, efficient, and reliable operation of the regulator, based on timing indication provided from the miscellaneous logic 240 (“MISC LOGIC” shown in FIG. 2).

The regulator 213 further includes a protection circuit 244 coupled to the miscellaneous logic 240. The protection circuit can be configured to monitor the system for issues such as overvoltage, undervoltage, overcurrent, overheating, etc., such as reverse current-indicator (RVI) circuit, input over-voltage protection (OVP) circuit, etc. When a fault is detected, the protection circuit 244 can signal the miscellaneous logic 240 to take corrective actions, such as adjusting the power output, disabling the system, or reducing power to protect the components. These circuits ensure the system operates safely and reliably under both normal and fault conditions.

As shown in FIG. 2, the regulator 213 also includes an inductor 226, which is located in the common node of the switches 224-1, 224-2. The inductor 226 acts as an energy storage element. When the high-side MOSFET 224-1 is on, current flows from the supply through the inductor 226 to the load (e.g., a circuit, component, device, etc. external to the regulator 213). During this phase, the inductor 226 can store energy as well. When the low-side MOSFET 224-2 is on, (and while the high-side MOSFET 224-1 is off) the inductor 226 can continue supplying current to the load (e.g., a circuit, component, device external to the regulator 213 that the regulator 213 provides a regulated voltage) as it discharges its stored energy.

As shown in FIG. 2, the regulator 213 also includes loop systems, such as a loop system 230 coupled to an input node of the inductor 226 and a loop system 228 coupled to an output node of the inductor 226. The loop systems 228 and 230 can be closed loop systems. As used herein, the term “closed loop system” refers to a control system that continuously monitors its output and compares it to the desired value, using negative feedback to adjust the input and minimize deviations.

Each loop system 228 and 230 can be or include one or more filters. As used herein, the term “filter” refers to an electronic circuit that allows certain frequencies or types of signals to pass through while attenuating or blocking others. The filter may be a low-pass filter (passing low frequencies and attenuates high frequencies), high-pass filter (passing high frequencies and attenuates low frequencies), or band-pass filter (BPF, passing a certain range of frequencies and attenuates frequencies outside this range), among others.

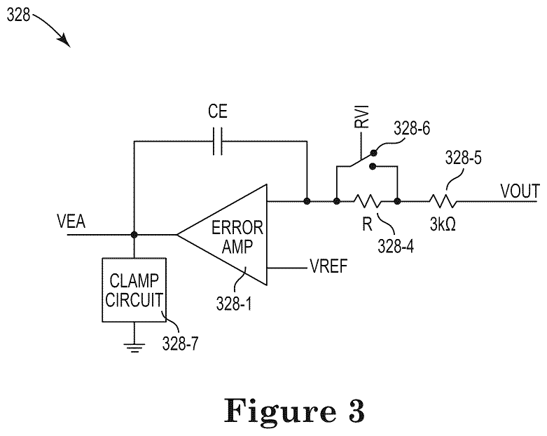

As shown in FIG. 2, the loop system 228 can be a multi-stage loop system, which includes an error amplifier 228-1, a transconductance stage 228-2, and a resistor-capacitor (RC) network for compensation of the error amplifier loop consisting of 228-1, 228-2. The RC network of the loop system 228 includes a capacitor (“CE” shown in FIG. 2) located between the output of the error amplifier 228-1 and the inverting input of the error amplifier 228-1. The RC network of the loop system 228 also includes a resistor 229 (“RE” shown in FIG. 2) formed by one or more resistors (e.g., the resistors 328-4 and 328-5 shown in FIG. 3). One side of the resistance 229 is coupled to the output node of the inductor and the other side of the resistance 229 is coupled to the inverting input of the error amplifier 228-1. The RC network can be a compensation network, which stabilizes the feedback loop by shaping the frequency response of the system, preventing oscillations and ensuring stability.

The resistor 229 (“RE”) functions as a voltage to current converter, taking the output voltage (“VOUT”) of the inductor and feeds it to the loop system 228 such that the error amplifier 228-1 compares that to the reference voltage (“VREF” shown in FIG. 2). The capacitor “CE” integrates the current through the resistor 229, influencing the phase margin of the loop system 228. The integration feature of “CE” and “RE” combination makes the loop system 228 to respond slowly due to variation in “VOUT” caused by load current transients.

The capacitor “CE” can control the high-frequency behavior of the feedback loop, filtering out high-frequency noise or oscillations, and influencing the phase margin of the loop system 228. The resistance 229 can function as a feedback resistor, taking output voltage (“VOUT”) of the inductor and feeds it to the loop system 228 such that the error amplifier 228-1 compares that to the reference voltage (“VREF” shown in FIG. 2 and alternatively referred to as the “reference output voltage”). The reference voltage “VREF” provides a target level that the regulator 213 is designed to keep the output voltage close to, even in the presence of changes in load or input voltage. The amplifier 228-1 can function as an error amplifier, which generates an output signal based on comparison between input signals (feedback and reference). For example, the error amplifier 228-1 can generate an analog signal as an output signal based on the difference between the two input signals. The error amplifier 228-1 outputs an output voltage (“VEA” shown in FIG. 2), which can be an error signal. The output voltage “VEA” can correspond to the difference between the two input voltages of the error amplifier 228-1.

The output voltage from the error amplifier 228-1 then can be input to the transconductance stage 228-2 as a inverting input, while an output voltage (“VOUT” shown in FIG. 2) of the inductor 226 can be input to the transconductance stage 228-2 as a non-inverting input. Accordingly, an output of the transconductance stage 228-2 corresponds to the difference between the two input voltages (“VOUT” and “VEA”) of the transconductance stage 228-2. Although not illustrated in FIG. 2, the error amplifier 228-1 can be further coupled to a clamp circuit, such as the clamp circuit 328-7 shown in FIG. 3.

The loop system 228 can operate to adjust the duty cycle of the converter's switches, thereby controlling “VOUT” to bring it closer to the target value defined by “VREF”. For example, when there is a change in “VOUT” (due to load transients, input voltage changes, or switching mode transitions), the error amplifier can detect the deviation from “VREF” and generates a corresponding adjustment signal. Accordingly, the settling time of the output voltage “VOUT” (e.g., how quickly it reaches its steady-state value after transitions, changes, etc.) can be influenced by how fast the error amplifier can respond to changes in the feedback loop.

The loop system 230 is coupled to an input node of the inductor 226 with a reverse current indicator (RVI) circuit 232 (that is also coupled to the input node of the inductor 226). More particularly, the RVI circuit 232 includes a comparator 232-1 coupled to an input node of the inductor 226 and configured to compare a voltage at the input node (received at a non-inverting input of the comparator 232-1) to the ground voltage (0V) (received at an inverting input of the comparator 232-1).

The comparator 232-1 can detect negative current through the transistor 224-2 and/or the inductor 226 (alternatively referred to as “reverse current” through the inductor 226). Once the negative current is detected, a signal indicative of such negative current is provided from the comparator 232-1 to a set input (“S” as shown in FIG. 2) of the flip-flop 232-2 (e.g., the RS flip-flop 232-2). The flip-flop 232 can prioritize Reset over Set. Such Flip-flops can be realized in multiple ways.

Negative current can occur when the stored energy in the inductor 226 is depleted during the off-phase of the switching cycle and/or when the load demand is low or non-existent, causing the regulator 213 to operate in a DCM. In this mode, the capacitor 229 can provide current to the load instead of the inductor 226.

When a signal indicative of negative current through the transistor 224-2 is received and applied to the set input of the flip-flop 232-2, this sets the flip-flop 232-2, causing the output “Q” to go high, which corresponds to an “RVI” signal provided to the protection circuit 244. In response to the “RVI” signal, the protection circuit 244 disables both the high-side and low-side drivers 222-1, 222-2, resulting in the switches 224-1, 224-2 to be turned off, allowing the regulator 213 to operate in a DCM and enter into a status indicative of the reverse current. Alternatively, when a “PON” signal is received and applied to a reset input (“R” as shown in FIG. 2), this resets the flip-flop, driving the “Q” output (and hence “RVI”) low. Therefore, the PON and RVI signals may not be high at the same time. The PON signal can be received (from the driver 222-1) when it is desired that the capacitor 229 is required to be recharged.

As used herein, a state, period, phase, cycle, etc. (e.g., in which the switch 224-1 is in an activated state in response to the “PON” signal) is referred to as a duty cycle, a PON state, PON period, PON phase, PON cycle of the switch 224-1, etc. Further, as used herein, a state, phase, cycle, etc., in which the switch 224-2 is in an activated state in response to the “NON” signal is referred to as a duty cycle, a NON state, NON period, NON phase, NON cycle of the switch 224-2, etc., respectively.

The loop system 230 includes a transconductance stage 230-1 coupled to an RC network, which includes two “branches” with a first branch including a resistor R1 and a capacitor C1, and a second branch including a resistor R2 and a capacitor C2. As shown in FIG. 2, the first branch is coupled to ground (through C1), a non-inverting input of the transconductance stage 230-1, and the second branch including R2, C2. Further, as shown in FIG. 2, the second branch is coupled to ground (through C2), an inverting input of the transconductance stage 230-1, and the first branch including R1, C1”.

The loop system 230 tracks and emulates the inductor current using the positive ramp voltage, “V_{Rampp}”, and the negative ramp voltage, “V_{Rampn}”. “V_{Rampp}” represents a synthesized signal that mimics the behavior of the inductor current, which is proportional to the voltage difference across the inductor 226.

In essence, the output signal along with the RAMP signal

$$( {V}_{OUT} + \frac{{g}_{m 2}}{{g}_{m 1}} \times ( {V}_{Rampp} - {V}_{Rampn} ) )$$

is compared against “VEA”. The filters 230 do not affect the DC regulation of the loop.

The outputs of the loop systems 228, 230 then can be input to an inverting input of the comparator 234. For example, a voltage received at the inverting input of the comparator corresponds to a sum of the output currents of the loop systems 228, 230 (e.g., gₘ₁×(Vₒᵤₜ−V_{EA})+gₘ₂×(V_{Rampp}−V_{Rampn})) multiplied by “R3”. The combination of these voltages received at the inverting input of the comparator 234 then can be compared against a common mode voltage 237 received at a non-inverting input of the comparator 234. As used herein, the term “common mode voltage” refers to the average voltage on the input(s) of the comparator 234. The common mode voltage may be any voltage such that the comparator operates in the linear region. The result of the comparison can be provided from the comparator 234 to the “control loop” (which can include timers 236, 238, 240, and/or a driver logic 242), which then can adjust the duty cycle of the power switches (e.g., switches 224-1, 224-2) to maintain optimal operation and respond appropriately to load transients based on the result of the comparison provided from the comparator 234.

FIG. 3 illustrates an error amplifier 328-1 (of the regulator 213 shown in FIG. 2) having a dynamically adjustable resistance in accordance with some embodiments of the present disclosure. The loop 328 can be analogous to the loop 228 shown in FIG. 2. For example, the error amplifier 328-1 can be analogous to the error amplifier 228-1 shown in FIG. 2, while the capacitor “CE” shown in FIG. 3 can be analogous to the capacitor “CE” shown in FIG. 2.

As shown in FIG. 3, the loop 328 can further include a clamp circuit 328-7 coupled to (e.g., an output node of) the error amplifier 328-1. The clamp circuit 328-7 can be configured to limit the error amplifier output drift in some instances, such as under light-load conditions, to prevent excessive deviation from the steady-state value. Accordingly, the clamp circuit 328-7 can contribute to reducing undershoot during load transients.

The resistance 229 (“RE”) shown in FIG. 2 may be formed by resistors 328-4 and 328-5. Although embodiments are not so limited, the resistor 328-5 can have a resistance value of 3 kiloohms.

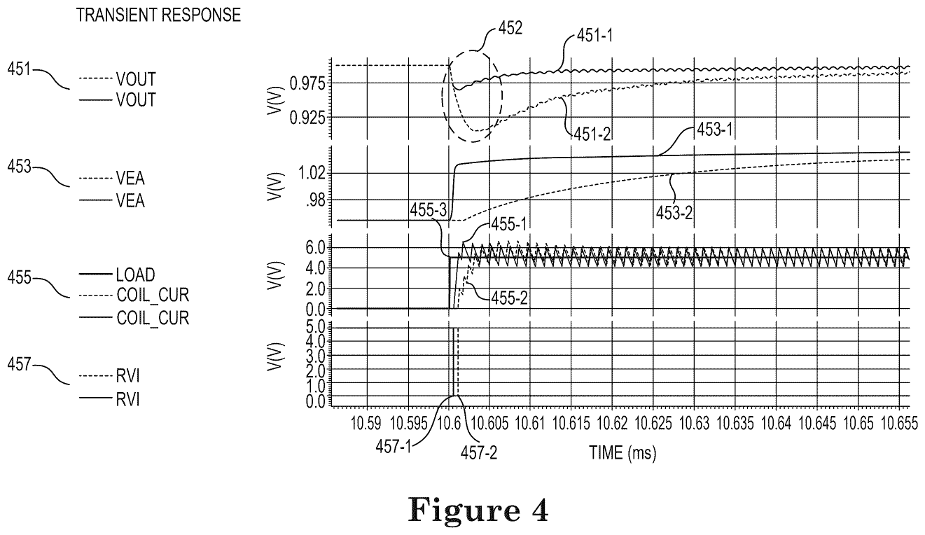

As shown in FIG. 3, the loop system 328 includes a switch 328-6, which may be a transistor switch, mechanical switch, etc., although embodiments are not so limited. The switch 328-6 can be controlled (e.g., activated or deactivated) by a RVI signal (“RVI” shown in FIG. 3 and received from the RVI circuit 232), which can be driven high or low by the RVI circuit 232. For example, when the RVI circuit 232 drives the RVI signal high (indicating that the voltage regulator 213 has entered a status indicative of the reverse current), it can activate the switch 328-6, allowing current to flow through it. Conversely, when the RVI signal is driven low (indicating that the voltage regulator 213 has exited the status indicative of the reverse current), the switch 328-6 can deactivate, preventing current from flowing through it. When activated by the RVI signal, switch 328-6 can form a bypass current path around resistor 328-4. For instance, once activated, the current may flow through switch 328-6 rather than resistor 328-4. Accordingly, once the switch 328-6 is activated, the resistance “RE” can be adjusted to a lower value by excluding the resistance of resistor 328-4. As described in connection with FIG. 4, dynamically adjusting the resistance 229 can reduce voltage undershoot and enable faster recovery of the error amplifier output during load transients.

FIG. 4 illustrates a number of graphs showing transient responses of a regulator (e.g., regulator 213 shown in FIG. 2) having an error amplifier with improved load transient performance in accordance with some embodiments of the present disclosure. Graph 451 shows states of an output voltage of a regulator. For example, signal 451-1 shows the response of the output voltage of the regulator 213, while signal 451-2 shows the response of the output voltage of a regulator that may not be implemented with an error amplifier (e.g., the error amplifier 228 shown in FIG. 2) having the improved load transient performance described in embodiments of the present disclosure.

Graph 453 shows states of an output of an error amplifier. For example, signal 453-1 shows the response of the output of the error amplifier 228, while signal 453-2 shows the response of the output of an error amplifier that may not have the improved load transient performance described in embodiments of the present disclosure.

Graph 455 shows states of inductor current (e.g., the current flowing through the inductor 226) as indicated by signals 455-1 and 455-2 and the load current (e.g., the current flowing from the output of the converter into the load) as indicated by the signal 455-3. For example, signal 455-1 shows the response of the inductor current of the regulator 213, while signal 455-2 shows the response of the inductor current of a regulator that may not be implemented with an error amplifier (e.g., the error amplifier 228 shown in FIG. 2) having the improved load transient performance described in embodiments of the present disclosure.

Graph 457 shows the control signal (e.g., the RVI signal provided by the RVI circuit 232) indicative of a reverse current. As shown by graph 457, the RVI signals are driven low respectively at 457-1 and 457-2 due to the high side switch 224-1 being activated, for example.

While both signals 451-1 and 451-2 show voltage undershoot (as indicated by the section 452) when the RVI signal is driven low, signal 451-1 exhibits reduced voltage undershoot and faster recovery, settling at approximately 1.0V. Similarly, compared to signal 453-2, signal 453-1 shows a faster recovery of the error amplifier output, settling at approximately 1.05V.

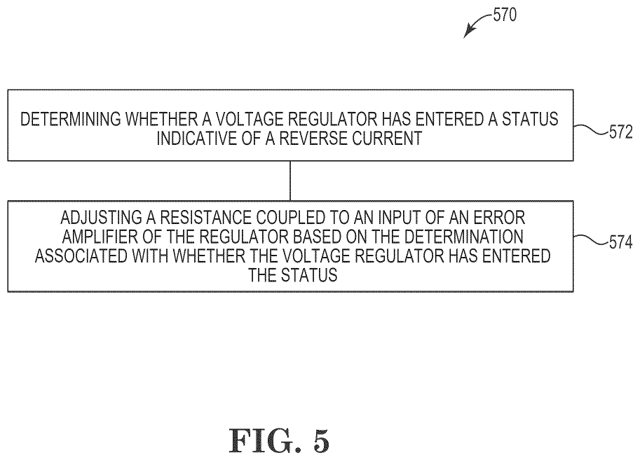

FIG. 5 is a flow diagram corresponding to a method for operating a voltage regulator having an error amplifier with improved load transient performance in accordance with some embodiments of the present disclosure. The method 570 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 570 is performed by the voltage regulator 113, 213 of FIGS. 1 and 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At 572, whether a voltage regulator (e.g., the voltage regulator 113, 213 shown in FIGS. 1 and 2, respectively) has entered a status indicative of the reverse current can be determined. For example, whether the voltage regulator 113, 213 has entered the status indicative of the reverse current can be determined based on respective status of one or more switches (e.g., the switches 224-1, 224-2 shown in FIG. 2) coupled to an inductor (e.g., the inductor 226 shown in FIG. 2) of the regulator 113, 213 in parallel.

At 574, a resistance (e.g., the resistance 229 shown in FIG. 2) coupled to an input of an error amplifier 228-1 of the regulator 113, 213 can be adjusted based on the determination associated with whether the voltage regulator 113, 213 has entered the status to improve load transient performance of the error amplifier 228-1. For example, the resistance 229 can be adjusted to a first value responsive to determining that the voltage regulator 113, 213 has entered the status indicative of the reverse current. Further, for example, the resistance 229 can be adjusted to a second value greater than the first value responsive to determining that the voltage regulator 113, 213 has exited the status indicative of the reverse current. In some embodiments, the one or more switches can be controlled (e.g., activated or deactivated) based at least in part on an output of the error amplifier 228-1.

In some embodiments, the resistance 229 can be formed of a first resistor 328-4 and a second resistor 328-5. Further, the voltage regulator 113, 213 can include a switch 328-6 coupled to the second resistor 328-5 in parallel with the first resistor 328-4. Continuing with this example, the resistance 229 can be adjusted to the first value by activating the switch 328-6 to create a bypass path around the first resistor 328-4. Further, the resistance 229 can be adjusted to the second value by deactivating the switch 328-6 to allow current flow through the first resistor 328-4.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
determining whether a voltage regulator has entered a status indicative of a reverse current; and
adjusting, to improve load transient performance of an error amplifier of the regulator, a resistance coupled to an input of the error amplifier based on the determination associated with whether the voltage regulator has entered the status indicative of the reverse current.

2. The method of claim 1, further comprises determining whether the regulator has entered the status indicative of the reverse current based on respective status of one or more switches coupled, in parallel, to an inductor of the regulator, and wherein a voltage at an output node of the inductor corresponds to an output voltage of the voltage regulator.

3. The method of claim 2, further comprising activating or deactivating the one or more switches based at least in part on an output of the error amplifier.

4. The method of claim 1, wherein adjusting the resistance coupled to the input of the error amplifier of the regulator based on the determination associated with whether the voltage regulator has entered the status indicative of the reverse current further comprises:
adjusting the resistance to a first value responsive to determining that the voltage regulator has entered the status indicative of the reverse current; and
adjusting the resistance to a second value greater than the first value responsive to determining that the voltage regulator has exited the status indicative of the reverse current.

5. The method of claim 4, wherein the resistance comprises a first resistor and a second resistor, and wherein the voltage regulator further comprises a switch coupled to the second resistor in parallel with the first resistor.

6. The method of claim 5, further comprises adjusting the resistance to the first value by activating the switch to create a bypass path around the first resistor.

7. The method of claim 5, further comprises adjusting the resistance to the second value by deactivating the switch to allow current flow through the first resistor.

8. A voltage regulator, comprising:
an inductor coupled to an intermediate node located between a first switch and a second switch respectively coupled to a power source and ground, wherein a voltage at an output node of the inductor corresponds to an output voltage of the voltage regulator; and
a first circuit coupled to an output node of the inductor, the first circuit comprising:
an error amplifier configured to compare the output voltage to a reference voltage; and
a resistance coupled to a first input of the error amplifier, wherein the resistance is adjusted to a first value or a second value greater than the first value based on whether the voltage regulator has entered a status indicative of a reverse current.

9. The voltage regulator of claim 8, wherein a second input of the error amplifier configured to receive a reference voltage, and wherein the error amplifier is configured to compare an output voltage with the reference voltage.

10. The voltage regulator of claim 8, wherein an output of the error amplifier is coupled to the first input via a capacitor to form a feedback loop including the first input and the output of the error amplifier.

11. The voltage regulator of claim 8, further comprising a driver logic configured to:
generate a first activation signal to cause the first switch to be activated; and
generate a second activation signal to cause the second switch to be activated.

12. The voltage regulator of claim 11, wherein the driver logic is further configured to indicate whether the voltage regulator has entered the status indicative of the reverse current.

13. The voltage regulator of claim 8, wherein the resistance is adjusted to the first value in response to the voltage regulator being determined to have entered the status indicative of the reverse current.

14. The voltage regulator of claim 8, wherein the resistance is adjusted to the second value in response to the voltage regulator being determined to have exited the status indicative of the reverse current.

15. The voltage regulator of claim 8, further comprising:
a second circuit coupled to an input node of the inductor, the second circuit tailored for emulating an inductor current of the inductor.

16. The voltage regulator of claim 8, wherein the voltage regulator is a DC-DC converter.

17. A voltage regulator, comprising:
driver logic configured to:
generate a first activation signal to cause a first switch coupled to a power source to be activated; and
generate a second activation signal to cause a second switch coupled to ground to be activated;
an inductor coupled to an intermediate node located between the first switch and the second switch, wherein a voltage at an output node of the inductor corresponds to an output voltage of a voltage regulator; and
a first circuit coupled to an output node of the inductor, the first circuit comprising:
an error amplifier;
a resistance coupled to an input of the error amplifier and comprising a first resistor and a second resistor; and
a switch coupled to the second resistor in parallel with the first resistor to create a bypass path around the first resistor when the switch is activated.

18. The voltage regulator of claim 17, wherein the driver logic configured to activate the switch to create a bypass path around the first resistor in response to the first switch and the second switch being deactivated.

19. The voltage regulator of claim 17, wherein the driver logic configured to deactivate the switch to allow current flow through the first resistor in response to the first switch or the second switch being activated.

20. The voltage regulator of claim 17, wherein the driver logic is configured to cause the first switch and the second switch to be activated or deactivated based at least in part on an output of the error amplifier.
